(19) United States
(12) Patent Application Publication
(10) Pub. No.: US 2015/0029612 A1
(43) Pub. Date: Jan. 29, 2015

(54) Dual Pass Perpendicular Magnetic Recording

(71) Applicant: William Haines, San Jose, CA (US)

(72) Inventor: William Haines, San Jose, CA (US)

(21) Appl. No.: 13/952,524

(22) Filed: Jul. 26, 2013

(51) Int. Cl. G11B 5/09

(52) U.S. Cl. CPC G11B 5/09
USPC 360/75

(57) ABSTRACT

Dual Pass Perpendicular Magnetic Recording is an invention to increase the storage capacity of disk drives and provides faster data transfer when reading data from a disk drive operating in this mode. By using two passes of the recording head to write a data track, more magnetic states are created than in conventional or shingled magnetic recording. This allows a higher storage capacity to be achieved.

### CROSS-REFERENCE TO RELATED APPLICATIONS

This application claims the benefits of provisional application 61/676,209 filed Jul. 26, 2012 by William G. Haines titled “Dual Track Perpendicular Magnetic Recording for Enhanced Storage Density and Increased Data Transfer Rates” which is incorporated herein by reference.

### FIELD OF THE INVENTION

The present application relates to magnetic storage systems, known as disk drives.

### BACKGROUND

Perpendicular recording has been adopted throughout the disk drive industry due to its capabilities for high areal density storage. Shingled writing and two dimensional magnetic recording techniques have been proposed to extend the areal storage capabilities of perpendicular recording. Two dimensional magnetic recording uses multiple read head passes or multiple read sensors to be able to fully compensate for adjacent track interference effects but this comes at substantial operational complexity and cost. The invention of Dual Pass Perpendicular Recording (DPPR) is intended as a means to reap the benefits of 2D magnetic recording but with a much simpler implementation.

The need to store digital content continues to grow exponentially with time. The resulting demand for higher performance, lower cost magnetic data storage has led to a continued increase in areal storage density in disk drives. This increased storage capacity has been achieved through increases in the linear bit density along the track and in a reduction in track width allowing more tracks to be recorded. The achievable storage capacity is limited by the physical dimensions of the recording head which consists of a writing element and a separate reading element. In conventional PMR (Perpendicular Magnetic Recording) the writing element magnetizes the recording medium normal to the disk plane with either a positive or negative magnetization. The reading element then follows the track created by the writing element and reads back the magnetization pattern created by the recording head. Adjacent tracks are written on both sides of the recorded data and as a consequence the desired read element width is less than the write width to minimize ATI (Adjacent Track Interference). Modern disk drives adjust the track density and the linear recording density in order to achieve acceptable OTRC (Off Track Read Capability) which is on order of 10% of the track pitch in commercially available devices. Since the recording system SNR decreases with both increasing track density (due to ATI) and increasing linear recording density (due to reduced signal levels) different recording heads will optimize performance at different track densities and linear recording densities (due to variations in read width, write width, erase band width, head/media spacing and sensor SNR). The ability to create low cost, high performance data storage devices depends on the ability to optimize the recording conditions for each head/media pair. This is a shortcoming of bit patterned recording as the media fixes both the track density and linear density at which the recording head must operate, thus eliminating the possibility of optimizing the recording conditions for a specific recording head to achieve maximum storage capability. DPPR (Dual Pass Perpendicular Recording) maintains the features of being adjustable to optimize the storage capacity of a head/media pair while offering enhanced storage capacity over conventional PMR.

### DESCRIPTION

In conventional PMR the data track width is roughly equal to the write width of the head. Multiple adjacent track writes are allowed on either side of the data track. The interaction of the multiple adjacent track writes degrades the SNR of the data track and limits the recording density that it can achieve. Optimization of track width and the linear recording density through Channel Quality Measurements can be used to guarantee satisfactory performance.

In shingled magnetic recording (SMR) adjacent track writes are only allowed on one side of the data track and are limited in quantity. This reduces the degradation of the SNR from adjacent tracks and allows a higher areal density to be achieved.

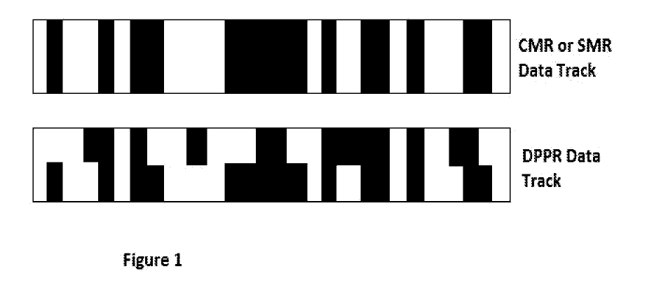

FIG. 1 in the drawing illustrates the difference between conventional PMR, shingled PMR and Dual Pass Perpendicular Recording. The top track represents a typical magnetization pattern created in conventional or shingled recording. In Dual Pass Perpendicular Recording the track is written in two steps. In the second writing step the recording head is displaced in the cross track direction and the first track is partially overwritten. The bottom track in FIG. 1 shows the resulting magnetization after the head was displaced a partial track width and then written again.

The key innovation in DPPR is to carefully control the data writing process to create “constructive” interference between the data written on successive write passes. The read head then is positioned to straddle the boundary between the written passes and to simultaneously determine the data written in both passes. By the term “constructive” interference it is meant any technique by which the data written in one of the write passes helps to determine the data written in the adjoining write pass. Two techniques that may be used to precisely write the data on adjacent passes to enable the simultaneous reading of both passes are staggered writing and orthogonal encoding. In staggered writing the written transitions in passes adjacent to each other are offset by a fixed distance, typically about half of the minimum transition spacing. This can be accomplished, for example, by doubling the write clock frequency and having one pass write transitions only on even write clock pulses while the adjacent pass writes transitions only on odd write clock pulses. The second technique is to use different data encoding schemes on adjacent passes. In a 8/10 code eight data bits are encoded as 10 code bits. This means that there are 4 different non overlapping (orthogonal) encode schemes possible. These four sets can be represented by 1xxxx1xxxx, 1xxxx0xxxx, 0xxxx1xxxx and 0xxxx0xxxx where the x′s represent the data bits. By choosing a different encode scheme for first and second write passes it enhances the ability to discriminate the read back signal into the components for the first and second pass respectively. The coding differences between adjacent written passes also provides a capability to servo on data.

A key technical challenge is to precisely write the dual passes to maintain the synchronous relationship of the written data on both passes. If the spin speed varies from one write pass to the next during the data writing process it could produce errors in the readback of the dual pass written data. To compensate for spin speed variation during the data writing process it may be necessary to adjust the write clock frequency on the fly to maintain a constant FCI (Flux changes per inch of track length). This may be enabled by simultaneously reading while writing on one transducer or by reading with one head while writing with another using a “clock” head to accurately time the written transitions of one track to the next. Other techniques for measuring spin speed variation could also be used to provide a control signal that would vary the write clock frequency and this has been implemented in commercially available hardware.

DPPR may be operated in a conventional mode with many writes on adjacent tracks on both sides of the data track or in a shingled mode where adjacent track writes are limited to one side of the data track and are restricted in quantity.

In DPPR higher data storage densities are created by increasing the number of magnetic states detected by the read element. In conventional and shingled perpendicular magnetic recording the magnetization states are either +M or −M. By using a second recording pass that is partially offset in the cross track direction fractional recording states are created. If the second recording pass is offset by ½ of the reader width than the detectable states are +M, −M and 0M. If the second recording pass is offset by ⅓ or ⅔ of the reader width the detectable states are +M, ⅓M, −⅓M and −M. As will be appreciated by someone who is skilled in the art various encoding schemes may be used to provide enhanced data storage capability from these additional recording states.

In DPPR the reader straddles the overlap region between the first and second recording passes while in conventional and shingled magnetic recording the reader avoids the boundary between adjacent write passes. By having synchronous recording and complementary encoding the interaction of the adjacent write passes is transformed from a source of noise to a source of signal improving the detectability of data.

In one preferred embodiment of this invention the storage capacity is increased by 60% by writing the two DPPR passes each at 80% of conventional PMR linear density to give a net linear density of 160% with a 1.6× increase in read back data transfer rate while maintaining the same track pitch of conventional recording. This allows individual sectors to be written in the DPPR mode interspersed with conventionally recorded data.

Another preferred embodiment of the invention is the ability to remotely enable a disk drive to employ DPPR. A customer who needed more storage space or increased data throughput could purchase a key that would activate the DPPR mode and the conversion of data from other modes to DPPR could be monitored remotely to insure successful completion. SMART system data could be used to determine the health and suitability of the device for conversion to include DPPR modes.

To optimize the recording performance the use of Channel Quality Measurements (CQM) can be used to determine optimum parameter settings. CQMs can include measures of the amount of noise necessary to add to the read channel filters to degrade the error rate to a specified level, or other computational measures provided by the channel. Another method of optimizing performance is to measure how far off track the read sensor can be and still read the data. The OTRC (Off Track Read Capability) can be set to a threshold and the recording density and recording parameters increased or decreased until the threshold performance is met.

Modern recording heads provide means for adjusting the head/media spacing through the application of an electrical current to one or more heating elements. Changing the head/media spacing can change the values of parameters such as write width and erase band width. It should be appreciated that optimal performance for DPPR may require different head/media spacings for the first writing pass compared to the second writing pass. This adjustment is head specific and different heads may require different adjustments. Write pre-compensation may also be pattern dependent and be optimized to account for the interaction between the first recording pass and the second recording pass. Usual recording parameters of write current, write current overshoot and overshoot duration may also be beneficially varied to optimize performance.

While the present invention has been particularly shown and described with reference to the preferred embodiments, it will be understood by those skilled in the art that various changes in form and detail may be made without departing from the spirit and scope of the invention. Accordingly, the disclosed invention is to be considered merely as illustrative and limited in scope only as specified in the appended claims

What is claimed:

1. A magnetic data storage system comprising: a magnetic recording head, a moving magnetic recording medium, positioning systems that can move the writing and reading elements accurately in the cross track direction and a read/write recording channel (controller) that controls the recording and read back of data from the magnetic recording medium, wherein a data track is written in two passes of the recording element with the second pass displaced in the cross track direction from the first pass by a partial track width

2. The storage system as recited in claim 1, where the cross track displacement between recording passes, the data track width and the linear recording density are adapted for writing data successively in two passes of the magnetic recording head over the magnetic recording medium prior to being read from the magnetic medium, wherein Channel Quality Measurement criteria are used to optimize the recording conditions of the first and second recording pass.

3. The storage system as recited in claim 1, where the cross track displacement between recording passes, the data track width and linear recording density are adapted for writing data successively in two passes of the magnetic recording head over the magnetic recording medium prior to being read from the magnetic medium, wherein off track read capability criteria are used to optimize the recording conditions of the first and second recording pass.

4. The storage system as recited in claim 1, where there is a coherent relationship between the first and second writing passes

5. The storage system as recited in claim 1, where there is a synchronous but incoherent relationship between the recording passes

6. The storage system as recited in claim 1 where different encoding schemes are used in the first and second recording passes to facilitate servo detection

7. The storage system as recited in claim 1 where different encoding schemes are used in the first and second recording passes to facilitate recovery of clocks and data

8. The storage system as recited in claiml where data may be stored in three different modes including a conventional mode where data is written in one pass of the recording head, a shingled mode where the track width is trimmed by writing an adjacent track on one side only at a spacing less than the write width of the head and, a third mode where the data is written in two passes of the recording head with the second pass being offset from the first pass by a distance less than the track width

9. The magnetic data storage system as recited in claim 1, wherein the controller is adapted for organizing data to be written to the magnetic medium such that the data is written successively in two adjacent passes of the magnetic medium and read from the magnetic medium in a single pass.

10. The magnetic data storage system as recited in claim 1, wherein the writer element overlaps a second data track while writing a first data track, wherein the first data track is adjacent the second data track.

11. The magnetic data storage system as recited in claim 1, wherein the reader element is positioned above the two adjacent data tracks while reading the two adjacent data tracks concurrently.

12. The magnetic data storage system as recited in claim 1, wherein the magnetic data storage system employs shingled magnetic recording to store data.

13. A method, comprising: receiving data to be written to a magnetic medium, wherein adjacent flux transitions in the magnetic medium are arranged in a staggered orientation such that any two centers of the adjacent flux transitions do not lie along a common line in a cross-track direction; organizing the data to be written successively to adjacent flux transitions of the magnetic medium such that the data is reproducible when read back from the adjacent flux transitions concurrently; and writing the data successively to the adjacent flux transitions, wherein the data is written such that data in adjacent flux transitions is staggered.

14. The method as recited in claim 13, wherein organizing the data comprises splitting the data into a first group and a second group, and wherein writing the data comprises: writing the first group data to the data track in a first pass; and writing the second group data to the data track in a second pass, wherein the first data is adjacent the second data, and wherein none of the first group data lies on a common line in a cross-track direction with any of the second group data.

15. The method as recited in claim 13, further comprising overlapping a writer element with the second data track while writing the first data track.

16. The method as recited in claim 13, further comprising reading the first group data from the first data track and the second group data from the second data track in a single pass.

17. The method as recited in claim 13, wherein the sensor element is positioned above the overlap boundary of the first and second writing passes while reading the data track.

18. The method as recited in claim 13, wherein the writing is performed using a writer element of a magnetic head, and wherein a width of the writer element is greater than a width of a data track in a track width direction.

19. The method as recited in claim 13, wherein the width of the writer element is at least about a width of two data tracks in a track width direction.

20. The method as recited in claim 13, wherein organizing the data comprises logically splitting the data in two groups to be written to adjacent recording passes based on at least one of: an order of writing the data to the two recording passes and an order of reading the data from the two adjacent data tracks.

21. The method as recited in claim 13, wherein the data is written successively to the adjacent data tracks using shingled magnetic recording.

22. A magnetic data storage device that provides three or more modes of data storage with successively increasing densities of storage with one of the modes being Dual Pass Perpendicular Recording.

23. The device as recited in claim 22 where the ability to use the denser modes of storage is activated by a remote command or key provided over the internet

24. The device as recited in claim 22 where SMART (Self Monitoring, Analysis and Reporting Technology) data is analyzed to determine if device is capable of supporting denser modes of data storage
